(19) United States
(12) Patent Application Publication
(10) Pub. No.: US 2019/0165490 A1
(43) Pub. Date: May 30, 2019

(54) TERMINAL-EQUIPPED ELECTRIC WIRE, METHOD FOR MANUFACTURING TERMINAL-EQUIPPED ELECTRIC WIRE, AND ELECTRIC WIRE

(71) Applicant: Yazaki Corporation, Tokyo (JP)

(72) Inventors: Tomoya SATO, Shizuoka (JP); Naoki ITO, Shizuoka (JP); Yasunori NABETA, Shizuoka (JP)

(73) Assignee: Yazaki Corporation, Tokyo (JP)

(21) Appl. No.: 16/200,916

(22) Filed: Nov. 27, 2018

(30) Foreign Application Priority Data
Nov. 28, 2017 (JP) 2017-227438

(51) Int. Cl. H01R 4/18; H01R 43/048

(52) U.S. Cl. CPC H01R 4/185; H01R 11/12; H01R 43/048

(57) ABSTRACT

A terminal-equipped electric wire has an electric wire including a bonded portion formed at a part of a conductor exposed due to absence of a sheath at a part of the electric wire in a longitudinal direction and in which strands of the conductor are bonded to each other; and a terminal including a wire barrel portion, the wire barrel portion covering at least a part of the bonded portion. The bonded portion includes a load release portion configured to reduce stress applied to the conductor.

### CROSS REFERENCE TO RELATED APPLICATION

This application is based upon and claims the benefit of priority from the prior Japanese Patent Application No. 2017-227438 (filing date: Nov. 28, 2017), the entire contents of which are incorporated herein by reference.

### BACKGROUND

### Technical Field

The present invention relates to a terminal-equipped electric wire and the like, in particular, to an electric wire having a partially different form of a bonded portion where a plurality of strands is bonded to each other.

### Related Art

Conventionally, a terminal-equipped electric wire 301 as illustrated in FIGS. 13A to 13C is known (see JP 2009-231079 A).

The terminal-equipped electric wire 301 is formed as follows. First, an exposed conductor 305 at a distal end portion of an electric wire 307 (see FIG. 13A) in which a sheath 303 is removed to expose the conductor (core wire) 305 at one end is bonded by ultrasonic bonding (see FIGS. 13B and 14B).

That is, the distal end portion of the conductor 305, including a plurality of strands 311, is bonded by ultrasonically bonding the respective strands 311, thereby forming a bonded portion 309.

As illustrated in FIG. 14A, the bonded portion 309 is formed by sandwiching the strands 311 with a predetermined pressure by an anvil 317 and a horn 319 and ultrasonically vibrating the horn 319.

As a terminal 315 is fixed to the bonded portion 309 by crimping a wire barrel portion 313, it is possible to obtain the terminal-equipped electric wire 301 (see FIGS. 13C and 14C).

### SUMMARY

Incidentally, the conventional terminal-equipped electric wire 301 has a problem that there is a risk that strand breakage (core wire breakage) may occur at an end (end on a side of the sheath 303) 321 of the bonded portion 309 (see FIGS. 14B and 14C).

That is, if the bonded portion 309 has a single shape such as prismatic shape or cylindrical shape, the strand 311 is broken as illustrated in FIGS. 14B and 14C when the bonded portion 309 is formed or when the wire barrel portion 313 is crimped to crimp the terminal 315 onto the electric wire 307 having the bonded portion 309. Incidentally, those denoted by reference signs 311A and 311B in FIGS. 14A to 14C are broken strands.

More specifically, the bonded portion 309 is compressed so that the conductor 305 is pulled at a rear end portion (a right end portion in FIG. 14C) of the wire barrel portion 313 when crimping the wire barrel portion 313 or the like, and the strand 311 is broken, for example, at the end (a boundary portion between the bonded portion 309 and a non-bonded portion) 321 of the bonded portion 309.

Then, mechanical connection strength between the terminal 315 and the conductor 305 decreases, and an electrical resistance value between the terminal 315 and the conductor 305 increases (performance of a crimped portion deteriorates).

At the boundary portion 321, a value of residual stress is increased due to the influence of the bonding process so that the strand 311 is easily broken. Further, a sectional shape (shape of a cross section according to a plane orthogonal to the longitudinal direction) of the strand 311 sharply changes at the boundary portion 321 so that stress concentration is likely to occur.

As illustrated in FIG. 14B, the strand breakage sometimes occurs even when only the bonded portion 309 is formed.

The invention has been made in view of the above problems, and an object of the invention is to provide a terminal-equipped electric wire and the like in which a bonded portion is formed by bonding a part of a conductor and a wire barrel portion of a terminal is fixed to the bonded portion and which is capable of suppressing occurrence of breakage of a strand of the conductor.

A terminal-equipped electric wire according to first aspect of the present invention has an electric wire including a bonded portion formed at a part of a conductor exposed due to absence of a sheath at a part of the electric wire in a longitudinal direction and in which strands of the conductor are bonded to each other, and a terminal including a wire barrel portion, the wire barrel portion covering at least a part of the bonded portion. The bonded portion is provided with a load release portion configured to reduce stress applied to the conductor.

The load release portion may be provided in at least one end portion of the bonded portion in the longitudinal direction, and a diameter of the bonded portion may gradually increase toward an end of the, bonded portion in the load release portion.

A terminal-equipped electric wire according to second aspect of the present invention has an electric wire including a bonded portion formed at a part of a conductor exposed due to absence of a sheath at a part of the electric wire in a longitudinal direction and in which strands of the conductor are bonded to each other, and a terminal including a wire barrel portion, the wire barrel portion covering at least a part of the bonded portion. A diameter of the bonded portion gradually increases toward an end of the bonded portion in an end portion of the bonded portion.

The terminal-equipped electric wire according to the first aspect or the second. aspect may have one terminal fixed to a plurality of the electric wires.

A method for manufacturing a terminal-equipped electric wire according to third aspect of the present invention includes forming, in an electric wire, a bonded portion in which strands of a conductor are bonded to each other in at least a part of the conductor in a longitudinal direction exposed due to absence of a sheath at a part of the electric wire in the longitudinal direction. A terminal including a wire barrel portion is fixed to the electric wire such that the wire barrel portion covers at least a part of the bonded portion. At least one end portion of the bonded portion in the longitudinal direction is provided with a load release portion configured to reduce stress applied to the conductor.

An electric wire according to fourth aspect of the present invention includes a bonded portion, in which strands of a conductor are bonded to each other, formed at least at a part of the conductor in a longitudinal direction exposed due to absence of a sheath at a part of the electric wire in the longitudinal direction. A diameter of the bonded portion gradually increases toward an end. of the bonded portion in an end portion of the bonded portion.

According to the aspects of the present invention, a terminal-equipped electric wire and the like which is capable of suppressing occurrence of breakage of a strand of the conductor is provided.

### BRIEF DESCRIPTION OF DRAWINGS

FIG. 1 is a view illustrating a bonded portion formation step in a method for manufacturing a terminal-equipped electric wire according to an embodiment of the invention;

FIG. 2 is a view illustrating an electric wire in which the bonded portion is formed in the bonded portion formation step in the method for manufacturing the terminal-equipped electric wire according to the embodiment of the invention;

FIG. 3 is a view illustrating the terminal-equipped electric wire according to the embodiment of the invention;

FIG. 4A is a view illustrating a relationship between the bonded portion and a wire barrel portion of a terminal in the terminal-equipped electric wire illustrated in FIG. 3;

FIG. 4B is a modification of one illustrated in FIG. 4A;

FIG. 4C is a modification of one illustrated in FIG. 4A;

FIG. 4D is a modification of one illustrated in FIG. 4A;

FIG. 5A is an image view illustrating a configuration of the bonded portion formed in the bonded portion formation step in the method for manufacturing the terminal-equipped electric wire according to the embodiment of the invention;

FIG. 5B is an image view illustrating a configuration of the bonded portion formed in the bonded portion formation step in the method for manufacturing the terminal-equipped electric wire according to the embodiment of the invention;

FIG. 5C is an image view illustrating a configuration of the bonded portion. formed in the bonded portion formation step in the method for manufacturing the terminal-equipped electric wire according to the embodiment of the invention;

FIG. 6A is a perspective view of the electric wire illustrated in FIG. 2;

FIG. 6B is a perspective view illustrating an electric wire in which a bonded portion is formed in a bonded portion formation step in a method for manufacturing a terminal-equipped electric wire according to a first modification;

FIG. 7A is a view illustrating a bonded portion formation step in a method for manufacturing a terminal-equipped electric wire according to a second modification;

FIG. 7B is a view illustrating an electric wire including the bonded portion formed in FIG. 7A;

FIG. 8A is a view illustrating a bonded portion formation step in a method for manufacturing a terminal-equipped electric wire according to a third modification;

FIG. 8B is a view illustrating an electric wire including the bonded portion formed in FIG. 8A;

FIG. 9A is a view illustrating a bonded portion formation step in a method for manufacturing a terminal-equipped electric wire according to a fourth modification;

FIG. 9B is a view illustrating an electric wire including the bonded portion formed in FIG. 9A;

FIG. 10A is a view illustrating an electric wire in which a bonded portion is formed by a method for manufacturing a terminal-equipped electric wire according to a fifth modification;

FIG. 10B is a view illustrating an electric wire in which a bonded portion is formed by a method for manufacturing a terminal-equipped electric wire according to a sixth modification;

FIG. 10C is a view illustrating an electric wire in which a bonded portion is formed by a method for manufacturing a terminal-equipped electric wire according to a. seventh modification;

FIG. 10D is a view illustrating an electric wire in which a bonded portion is formed by a method for manufacturing a terminal-equipped electric wire according to an eighth modification;

FIG. 10E is a view illustrating an electric wire in which a bonded portion is formed by a method for manufacturing a terminal-equipped electric wire according to a ninth modification;

FIG. 11 is a view illustrating a terminal-equipped electric wire according to a modification in which a bonded portion is formed at an intermediate portion in the longitudinal direction of an electric wire and a terminal is fixed to the bonded portion;

FIG. 12 is a view illustrating a terminal-equipped electric wire according to a modification in which one terminal is fixed to a plurality of (for example, two) electric wires;

FIG. 13A is a view illustrating a conventional method for manufacturing a terminal-equipped electric wire;

FIG. 13B is a view illustrating a conventional method for manufacturing a terminal-equipped electric wire;

FIG. 13C is a view illustrating a conventional method for manufacturing a terminal-equipped electric wire;

FIG. 14A is a view illustrating the conventional method for manufacturing a terminal-equipped electric wire;

FIG. 14B is a view illustrating the conventional method for manufacturing a terminal-equipped electric wire; and

FIG. 14C is a view illustrating the conventional method for manufacturing a terminal-equipped electric wire.

### DETAILED DESCRIPTION

First, a method for manufacturing a terminal-equipped electric wire 1 (see FIG. 3) according to an embodiment of the invention will be described. For convenience of description, it is assumed that a predetermined direction of the terminal-equipped electric wire 1 is the front-rear direction (longitudinal direction of an electric wire 9), a predetermined direction orthogonal to the front-rear direction is the height direction, and a direction orthogonal to the front-rear direction and the height direction is the width direction.

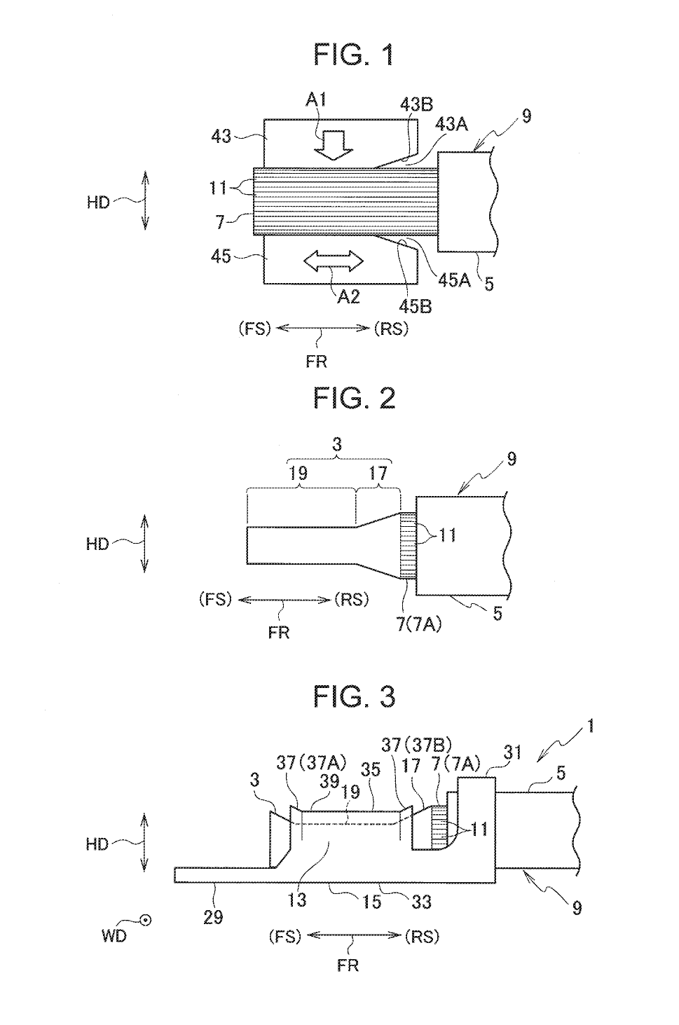

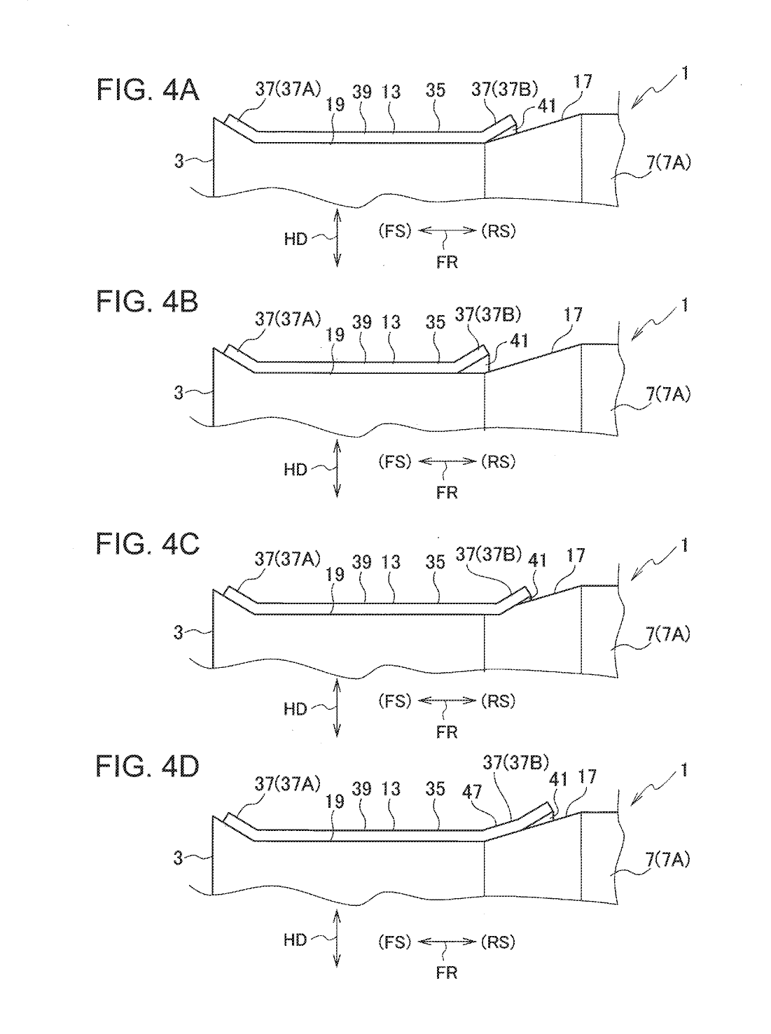

The terminal-equipped electric wire 1 is manufactured through a bonded portion formation step (see FIGS. 1, 2, and 6A) and a terminal fixing step (see FIGS. 3 and 4A).

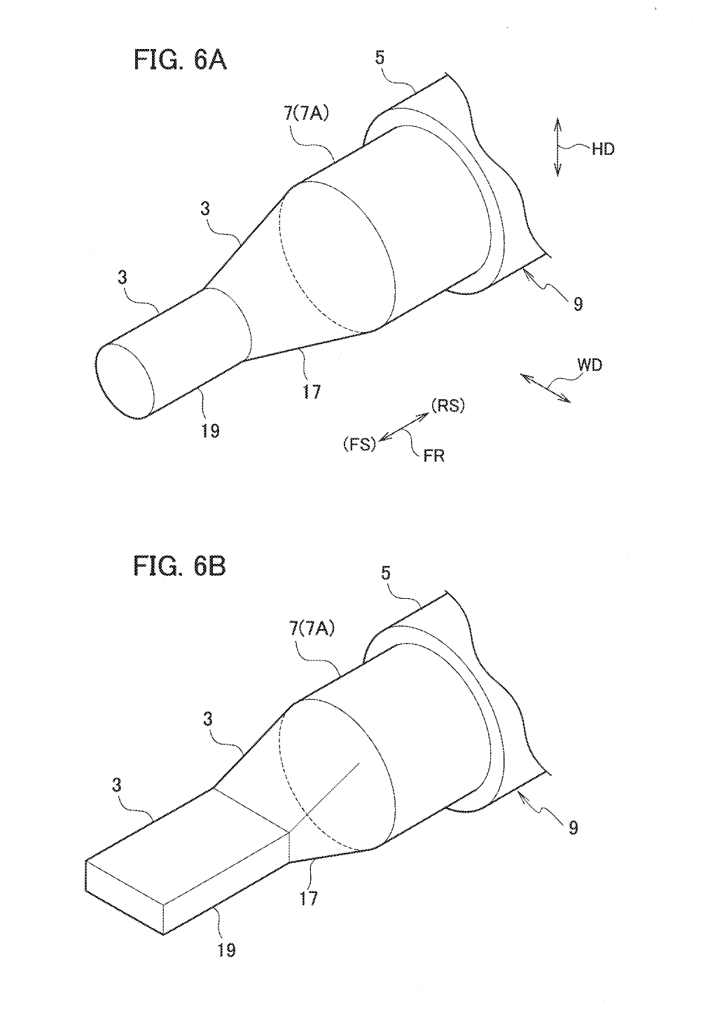

In the bonded portion formation step, a bonded portion 3 as illustrated in FIGS. 2 and 6A is formed. More specifically, the electric wire 9 in which a conductor 7 is exposed as a sheath 5 is not present over a predetermined length at a part (for example, one end portion) in the longitudinal direction (length direction) (for example, as a part of the sheath 5 is removed) is prepared in the bonded portion formation step.

Subsequently, a plurality of strands 11 forming the conductor 7 is ultrasonically bonded to each other in at least a part of the exposed conductor (exposed conductor) 7 in the longitudinal direction to bond the conductors 7 (the respective strands 11) to each other in the bonded portion formation step. As a result, the electric wire 9 with the bonded portion is manufactured (see FIGS. 2 and 6A).

In the terminal fixing step, a terminal (terminal fitting) 15 provided with a wire barrel portion 13 is fixed to the electric wire (electric wire with the bonded portion) 9 such that the wire barrel portion 13 wraps and covers at least a part of the bonded portion 3 formed in the bonded portion formation step (see FIGS. 3 and 4A).

A load release portion (stress reduction portion) 17 configured to reduce stress applied to the conductor 7 is provided in at least a part in the longitudinal direction of the bonded portion 3 formed in the bonded portion formation step as illustrated in FIG. 2 and the like.

The load release portion 17 is provided to reduce the stress generated at an end of the conductor 7, for example, the bonded portion 3 when forming the bonded portion 3. Further, the load release portion 17 is provided to reduce the stress generated at an end of the conductor 7, for example, the bonded portion 3 when the terminal 15 is fixed to the electric wire 9 such that the wire barrel portion 13 covers the bonded portion 3.

As illustrated in FIGS. 2, 6A, and 6B, the load release portion 17 of the bonded portion 3 before fixing of the terminal 15 is formed as a portion (for example, an enlarged diameter portion) whose diameter (outer diameter) gradually changes in the longitudinal direction.

As illustrated in FIGS. 2, SA, and 6B, the load release portion 17 before fixing of the terminal 15 is provided in at least one end portion (for example, a rear end portion) of the bonded portion 3 in the longitudinal direction. In the load release portion 17, the diameter of the bonded portion 3 gradually increases toward an end of the bonded portion 3.

Meanwhile, the electric wire 9 includes the conductor (core wire) 7 formed by gathering the plurality of strands 11 and the sheath (insulator) 5 covering the conductor 7.

The strand 11 of the conductor 7 is formed in an elongated cylindrical shape with metal such as copper, aluminum, and an aluminum alloy. The conductor 7 is configured in a form in which the plurality of strands 11 is twisted or a form in which the plurality of strands 11 collectively extends in a straight line.

The electric wire 9 has flexibility. lei addition, a cross section of a portion of the electric wire 9 where the sheath 5 is present, that is, the cross section taken along a plane orthogonal to the longitudinal direction is formed in a predetermined shape such as a circular shape.

A cross section of the conductor 7 at the portion of the electric wire 9 where the sheath 5 is present is formed in a substantially circular shape by bundling the plurality of strands 11 with almost no gap. A cross section of the sheath 5 at the portion of the electric wire 9 where the sheath 5 is present is formed in an annular shape having a predetermined width (thickness). The entire inner circumference of the sheath 5 is in contact with the entire outer circumference of the conductor 7.

As described above, the plurality of strands 11 for the conductor 7 is ultrasonically bonded to each other such that the conductors 7 are bonded to each other in the bonded portion 3. For example, the conductor 7 is made into a single wire in the bonded portion 3.

As illustrated in FIG. 1, the ultrasonic bonding between the strands 11 is performed using an anvil 43 and a horn 45. That is, a pressing force of an arrow A1 is applied to the conductor 7 (the strand 11) by the anvil 43, the conductor 7 is sandwiched between the anvil 43 and the horn 45, and the horn 45 is ultrasonically vibrated in a direction of an arrow A2, thereby ultrasonically bonding the strands 11 to each other.

The anvil 43 is provided with a load release portion forming portion (a cutout of a wall of the anvil 43) 43A configured to form the load release portion 17, and the horn 45 is also provided with a load release portion forming portion (a cutout of a wall of the horn 45) 45A configured to form the load release portion 17.

Further, the ultrasonic bonding between the strands 11 using the anvil 43 and the horn 45 is performed in a state where the anvil 43 is further moved closer to the horn 45 from the state illustrated in FIG. 1 (a state where the anvil 43 is further moved in the direction of the arrow A1 so that the load release portion forming portions 43A and 45A are substantially filled with the conductor 7).

Although the bonded portion 3 is formed by bonding the strands 11 to each other by ultrasonic bonding in the above description, the bonded portion 3 may be formed by bonding the strands 11 to each other by a bonding means other than the ultrasonic bonding. For example, the bonded portion 3 may be formed in the same manner as in the case of ultrasonic bonding by metallurgically bonding the strands 11 to each other at a temperature equal to or lower than a recrystallization temperature of the strand 11.

Further, the bonded portion 3 may be formed by treatment such as cold welding, friction stir welding, friction welding, electromagnetic welding, diffusion bonding, brazing, soldering, resistance welding, electron beam welding, laser welding, and light beam welding other than the ultrasonic treatment.

As illustrated in FIG. 2 and the like, the bonded portion 3 and the sheath 5 are apart from each other by a predetermined length, for example, in the longitudinal direction of the electric wire 9. As a result, a plurality of strands (a conductor in a non-bonded state) 7A, which is in contact with each other but is in a non-bonded state, is exposed between the bonded portion 3 and the sheath 5.

Further, the bonded portion 3 includes a body portion 19 and the load release portion 17. The body portion is positioned on one side (for example, the front side) of the bonded portion 3 in the longitudinal direction of the electric wire 9, and the load release portion 17 is positioned on the other side (for example, the rear side) of the bonded portion 3 in the longitudinal direction of the electric wire 9.

As a result, the body portion 19 of the bonded portion 3 by a predetermined length, the load release portion 17 of the bonded portion 3 by a predetermined length, the conductor 7A of the non-bonded state, and the conductor 7 covered with the sheath 5 (the portion of the electric wire 9 where the sheath 5 is present) are arranged in this order from the one end to the other end in the longitudinal direction of the electric wire 9 in the electric wire 9 before fixing of the terminal 15.

A sectional shape of the body portion 19 of the bonded portion 3 (a sectional shape taken along the plane orthogonal to the longitudinal direction) before fixing of the terminal 15 is formed in a circular shape (the body portion 19 is formed in a cylindrical. shape) as illustrated in FIG. 6A, but may be formed in another shape such as a rectangular shape as illustrated in FIG. 6B.

A cross section (cross section taken along the plane orthogonal to the longitudinal direction) of the conductor 7A in the non-bonded state before fixing of the terminal 15 is formed, for example, in a circular shape,

A sectional shape of the load release portion 17 (a sectional shape taken along the plane orthogonal to the longitudinal direction) of the bonded portion 3 before fixing of the terminal 15 gradually shifts from the sectional shape of the body portion 19 of the bonded portion 3 to the sectional shape of the conductor 7A in the non-bonded state as proceeding from a side of the body portion 19 toward the conductor 7A in the non-bonded state.

When viewed from the longitudinal direction of the electric wire 9, a size of an outer shape of the body portion 19 of the bonded portion 3 is smaller than a size of an outer shape of the conductor 7A in the non-bonded state, and for example, the body portion 19 of the bonded portion 3 is positioned at the inner side of the conductor 7A in the non-bonded state. Further, a central axis of the conductor 7A in the non-bonded state and a central axis of the body portion 19 of the bonded portion 3 coincide with each other.

As a result, the load release portion 17 of the bonded portion 3 is formed in a tapered shape of, for example, a truncated cone shape.

In the case where the load release portion 17 of the bonded portion 3 is formed. in the truncated cone shape, an inner space (space where the conductor 7 enters) between the load release portion forming portion 43A of the anvil 43 and the load release portion forming portion 45A of the horn 45 is formed in a truncated cone shape coinciding with the shape of the load release portion 17 in a state where the conductor 7 is sandwiched between the anvil 43 and the horn 45.

In FIG. 1 which is the cross-sectional view of the anvil 43 and the horn 45, a surface of the load release portion forming portion 43A of the anvil 43 is expressed by a linear inclined surface 43B and a surface of the load release portion forming portion 45A of the horn 45 is also expressed by a linear inclined surface 4513.

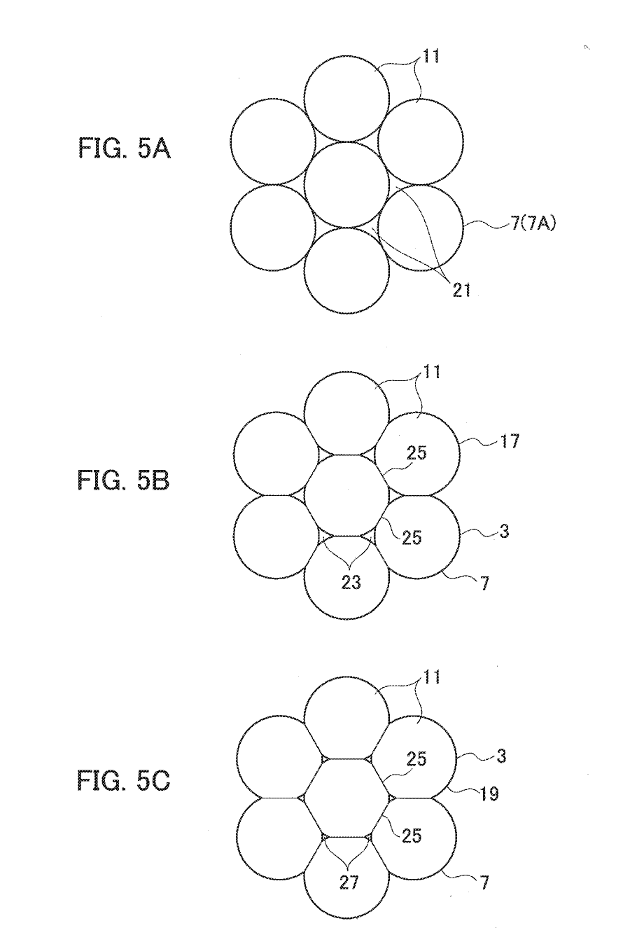

Here, a description will be given regarding a state of the strand 11 in the conductor 7A in the non--bonded state, a state of the strand 11 in the load release portion 17 of the bonded portion 3, and a state of the strand 11 in the body portion 19 of the bonded portion 3 with reference to FIGS. 5A to 5C. Incidentally, FIGS. 5A to 5C schematically illustrate the states of the strands 11.

The state (state of the cross section taken along the plane orthogonal to the longitudinal direction) of the strand 11 in the non-bonded state conductor 7A is formed as illustrated in FIG. 5A.

In FIG. 5A, the strands 11 are not plastically deformed but the strands 11 are only in contact with each other, and there is a gap 21 between the respective circular strands 11.

The state (state of the cross section taken along the plane orthogonal to the longitudinal direction) of the strand 11 in the load release portion 17 of the bonded portion 3 is formed as illustrated in FIG. 5B.

In FIG. 5B, the strands 11 are plastically deformed so that the strands 11 are bonded to each other at a linear portion 25, and a gap 23 exists between the respective circular strands 11 that are partially deformed.

The gap 23 is smaller than the gap 21 illustrated in FIG. 5A, and the linear portion 25 becomes shorter and the gap 23 becomes larger in the load release portion 17 of the bonded portion 3 from the side of the body portion 19 of the bonded portion 3 toward the conductor 7A in the non-bonded state.

The state (state of the cross section taken along the plane orthogonal to the longitudinal direction) of the strand 11 in the body portion 19 of the bonded portion 3 is formed as illustrated in FIG. 5C.

In FIG. 5C, the strands 11 are further plastically deformed so that the strands 11 are bonded to each other at the linear portion 25, and a gap 27 exists between the respective circular strands 11 that are partially deformed.

The linear portion 25 illustrated in FIG. 5C is longer than the linear portion 25 illustrated in FIG. 5B, and the gap 27 illustrated in FIG. 5C is smaller than the gap 23 illustrated in FIG. 5B.

The terminal 15 is formed, for example, by forming a flat metal material having a constant thickness into a predetermined shape, and then, appropriately folding the material formed into the predetermined shape. Therefore, a thickness of a wall in almost the entire portion of the terminal 15 is constant.

The terminal 15 has, for example, a mating terminal connection portion 29 to be connected to a mating terminal, the wire barrel portion 13, and an insulation barrel portion 31 arranged in this order from the front side to the rear side as illustrated in FIG. 3.

In the terminal-equipped electric wire 1, the longitudinal direction of the electric wire 9 or the conductor 7 and the front-rear direction of the wire barrel portion 13 (terminal 15) coincide with each other. In addition, one end of the electric wire 9 in the longitudinal direction is positioned on the front side, and the other end of the electric wire 9 in the longitudinal direction is positioned on the rear side.

A cross section (cross section taken along a plane orthogonal to the front-rear direction) of the wire barrel portion 13 before being crimped is formed in, for example, a U shape including a bottom plate portion (arc-shaped bottom plate portion) 33 whose thickness direction is substantially the height direction and a pair of side plate portions 35. The pair of side plate portions 35 is erected obliquely upward, respectively, from both ends of the bottom plate portion 33 in the width direction. A dimensional value of a portion between the pair of side plate portions 35 gradually increases from the lower side to the upper side.

A cross section (cross section taken along the plane orthogonal to the front-rear direction) of the insulation barrel portion 31 before being crimped is also formed in the “U” shape similar to the cross section of the wire barrel portion 13.

In the terminal-equipped electric wire 1, the bonded portion 3 and the wire barrel portion 13 are integrated as the wire barrel portion 13 is crimped, and the sheath 5 and the insulation barrel portion 31 are integrated as the insulation barrel portion 31 is crimped. Almost the entire inner surface of a cylinder of the wire barrel portion 13 is brought into contact with the bonded portion 3 with a biasing force by the crimping.

The crimping of the wire barrel portion 13 or the insulation barrel portion 31 is mainly performed as the pair of side plate portions 35 is plastically deformed so that the wire barrel portion 13 and the insulation barrel portion 31 are formed into a tubular shape (for example, a cylindrical shape). When the wire barrel portion 13 is crimped, the bonded portion 3 is sometimes slightly deformed.

Here, a relationship between the electric wire 9 and the terminal 15 in the front-rear direction will be described in more detail.

As described above, the body portion 19 of the bonded portion 3 by the predetermined length, the load release portion 17 of the bonded portion 3, the conductor 7A in the non-bonded state, and the conductor 7 covered with the sheath 5 are arranged in this order from the one end (front side) to the other end (rear side) in the longitudinal direction of the electric wire 9. The conductor 7 covered with the sheath 5 is much longer than the bonded portion 3 or the conductor 7A in the non-bonded state.

As illustrated in FIG. 4A, the wire barrel portion 13 of the terminal 15 is provided with bell mouth portions 37 (a front bell mouth portion 37A and a rear bell mouth portion 37B).

Therefore, the wire barrel portion 13 includes a body portion 39 and the pair of bell mouth portions 37, and the front bell mouth portion 37A, the body portion 39, and the rear bell mouth portion 37B are arranged in this order from the front side to the rear side in the wire barrel portion 13.

In the terminal-equipped electric wire 1, the body portion 39 of the wire barrel portion 13 is formed into a tubular shape having a constant diameter such as a cylindrical shape. On the other hand, the diameter changes in the bell mouth portion 37, and a gap 41 is formed between the bell mouth portion 37 and the bonded portion 3.

Further, a position of a rear end of the body portion 39 of the wire barrel portion 13 (a position of a boundary between the body portion 39 and the rear bell mouth portion 37B) and a position of a rear end of the body portion 19 of the bonded portion 3 (a position of a boundary between the body portion 19 and the load release portion 17) coincide with each other in the front-rear direction in the terminal-equipped electric wire 1 as illustrated in FIGS. 3 and 4A.

Further, a front end of the body portion 19 of the bonded portion 3 is positioned at the front side of the wire barrel portion 13 in the front-rear direction in the terminal-equipped electric wire 1, but the front end of the body portion 19 of the bonded portion 3 may be positioned at the front bell mouth portion 37A of the wire barrel portion 13 or may be positioned at the rear side of the front bell mouth portion 37A.

As illustrated in FIG. 4B, a position of a rear end of the body portion 39 of the wire barrel portion 13 may be positioned at the front side of a position of a rear end of the body portion 19 of the bonded portion 3 in the front-rear direction. That is, the body portion 39 of the wire barrel portion 13 may be positioned at the inner side of the body portion 19 of the bonded portion 3 in the front-rear direction.

Further, the position of the rear end of the body portion 39 of the wire barrel portion 13 may be positioned at the rear side (at the load release portion 17) of the position of the rear end of the body portion 19 of the bonded portion 3 in the front-rear direction as illustrated in FIG. 4C. In this case, a rear end portion of the body portion 39 of the wire barrel portion 13 bite a front end portion of the load release portion 17 of the bonded portion 3.

As illustrated in FIG. 4D, a load release portion engaging portion 47 having a shape (substantially matching shape) matching with the shape of the load release portion 17 may be provided between the body portion 39 of the wire barrel portion 13 and the rear bell mouth portion 37B. In this case, the load release portion engaging portion 47 is engaged with the front end portion of the load release portion 17.

Further, the front bell mouth portion 37A and the rear bell mouth portion 3713 may be removed.

Here, the terminal-equipped electric wire 1 manufactured by the above-described manufacturing method will be described.

As described above, the terminal-equipped electric wire 1 includes the electric wire 9 and the terminal 15. The conductor 7 is exposed due to the absence of the sheath 5 over the predetermined length in a part of the electric wire 9 in the longitudinal direction, and the conductor 7 is bonded at a part of the exposed conductor 7 to form the bonded portion 3 over the predetermined length.

The terminal 15 includes the wire barrel portion 13, and the wire barrel portion 13 covers at least a part of the bonded portion 3.

In the terminal-equipped electric wire 1, the load release portion 17 configured to reduce the stress of the conductor 7 is provided at the bonded portion 3.

In the terminal-equipped electric wire 1, the load release portion 17 is provided in at least one end of the bonded portion 3, and the diameter of the load release portion 17 gradually increases toward the end of the bonded portion 3.

Since the load release portion 17 is provided in a part of the bonded portion 3 according to the terminal-equipped electric wire 1, it is possible to suppress occurrence of strand breakage at the conductor 7 when fixing the terminal 15.

That is, when the wire barrel portion 13 is or has been swaged to crimp the terminal 15, a value of the stress generated at the conductor 7 by the load release portion 17 is reduced even if the bonded portion 3 is compressed so that the conductor 7 is pulled at the rear end portion of the wire barrel portion 13, and the strand breakage at the rear end of the bonded portion 3 is suppressed.

Then, a decrease of mechanical connection strength between the terminal 15 and the conductor 7 is suppressed, and an increase of an electrical resistance value between the terminal 15 and the conductor 7 is suppressed (deterioration in performance of a crimped portion is suppressed).

Further, the load release portion (the load release portion before fixing of the terminal 15) 17 of the bonded portion 3 is formed as the portion (for example, the enlarged diameter portion) whose diameter (outer diameter) gradually changes in the longitudinal direction. Thus, it is possible to eliminate a sudden change in the diameter of the conductor 7 at the boundary portion between the bonded portion 3 and the conductor 7A in the non-bonded state and to suppress the occurrence of stress concentration at the boundary portion according to the terminal-equipped electric wire 1. As a result, it is possible to suppress the breakage of the strand 11 at the boundary portion.

Further, the load release portion 17 of the bonded portion 3 is provided at the end portion of the bonded portion 3 in the longitudinal direction. Thus, it is possible to more reliably eliminate the sudden change in the diameter of the conductor 7 at the boundary portion between the bonded portion 3 and the conductor 7A in the non-bonded state and to more reliably suppress the occurrence of stress concentration at the boundary portion according to the terminal-equipped electric wire 1.

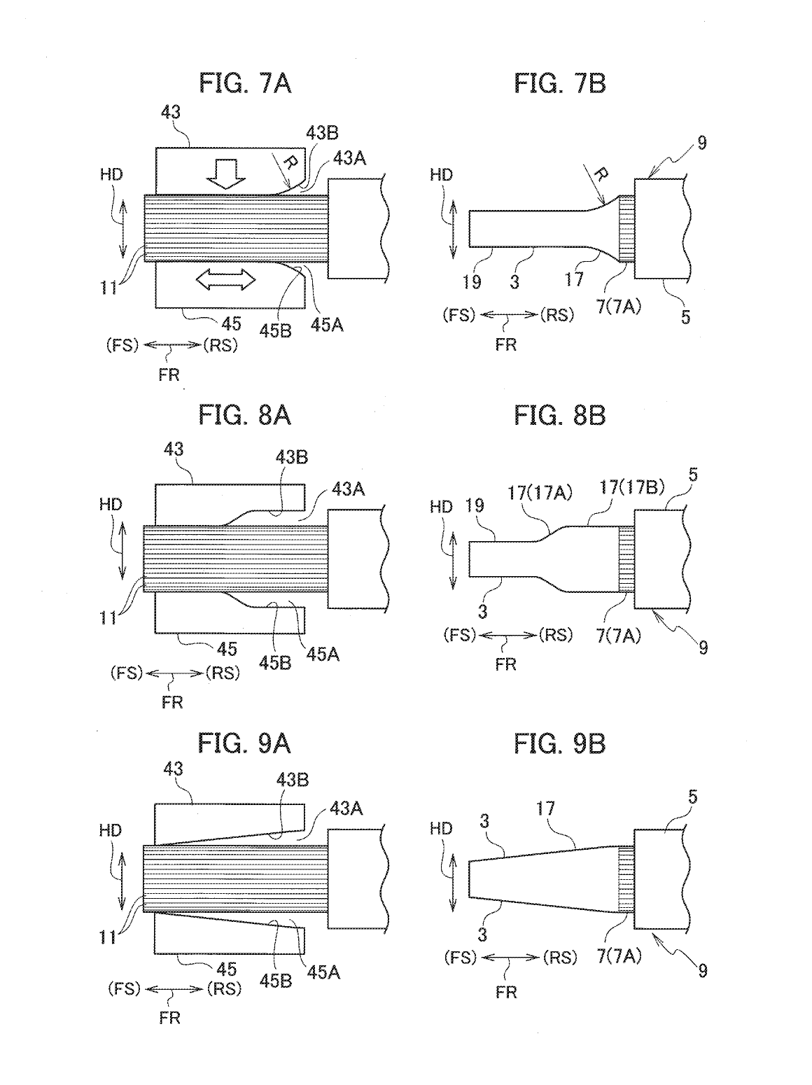

Meanwhile, the load release portion 17 of the bonded portion 3 is enlarged in diameter at a constant rate toward the end of the bonded portion 3 as illustrated in FIGS. 1, 2, 6A, and 6B in the above description, but the shape of the load release portion 17 may be appropriately changed as illustrated in FIGS. 7A to 10E.

That is, the inclined surface 43B of the anvil 43 and the inclined surface 45B of the horn 45 may be formed in an arc shape having a radius of R as illustrated in FIG. 7A. As a result, the rate at which the load release portion 17 of the bonded portion 3 is enlarged in diameter also gradually increases toward the end of the bonded portion 3. As illustrated in FIG. 7B, the load release portion 17 of the bonded portion 3 of the electric wire 9, formed using the anvil 43 and the horn 45 illustrated in FIG. 7A, has a shape matching with the shape of the load release portion forming portion 43A of the anvil 43 or the load release portion forming portion 45A of the horn 45.

As illustrated in FIGS. 8A and 8B, the load release portion 17 may be formed by a first load release portion 17A and a second load release portion 17B. The first load release portion 17A is positioned on the side of the body portion 19 and is formed in a shape (for example, a truncated cone shape) as illustrated in FIG. 1, FIG. 2, FIGS. 6A and 6B, or FIG. 7B, and the second load release portion 17B is formed in a cylindrical shape having an outer diameter substantially equal to or slightly smaller than the outer diameter of the conductor 7A in the non-bonded state.

Incidentally, the second load release portion 17B may be formed in a truncated cone shape. However, when the second load release portion 17B has the truncated cone shape, it is assumed that a change rate of a diameter of the second load release portion 17B is lower than that of the first load release portion 17A.

As illustrated in FIGS. 9A and 9B, the entire load release portion 17 may be formed in a shape (for example, a truncated cone shape) that is gradually enlarged in diameter from the front end toward the rear end.

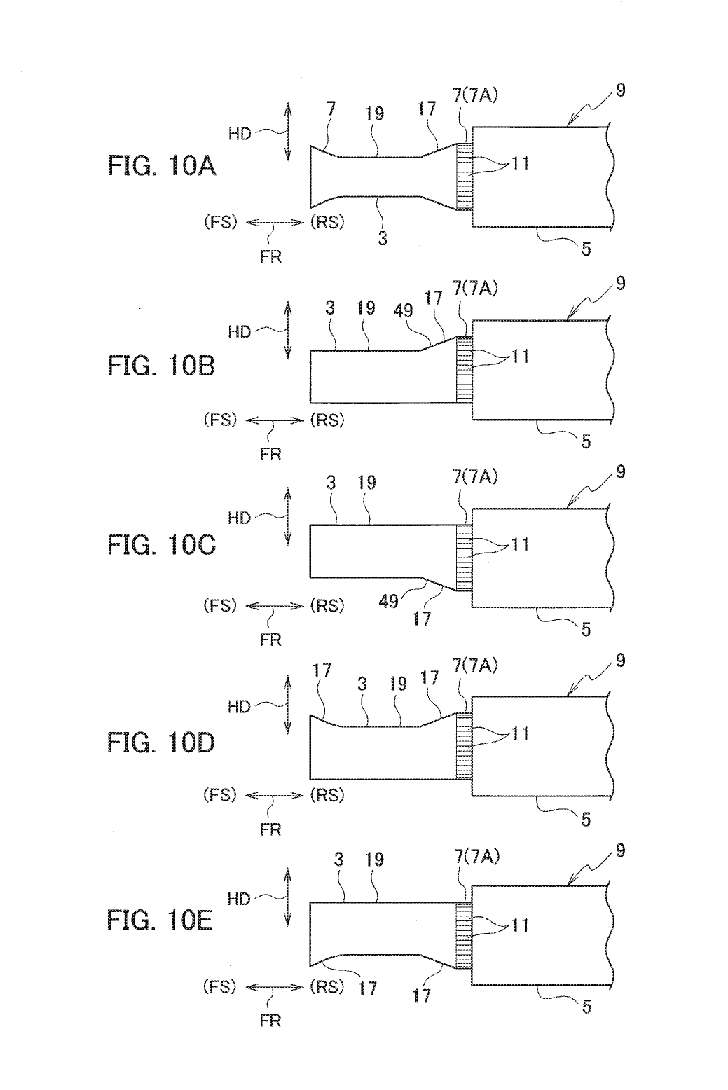

As illustrated in FIG. 10A, the load release portion 17 may be provided at both end portions of the bonded portion 3 in the longitudinal direction. As illustrated in FIG. 10B, the load release portion 17 may be formed by providing an inclined surface 49 only on a side opposite to the bottom plate portion 33 of the wire barrel portion 13. As illustrated in FIG. 10C, the load release portion 17 may be formed by providing the inclined surface 49 only on a side of the bottom plate portion 33 of the wire barrel portion 13.

As illustrated in FIG. 10D, the load release portion 17 in the form illustrated in FIG. 10B may be provided at both end portions of the bonded portion 3 in the longitudinal direction. As illustrated in FIG. 10E, the load release portion 17 in the form illustrated in FIG. 10C may be provided at both end portions in the longitudinal direction of the bonded portion 3.

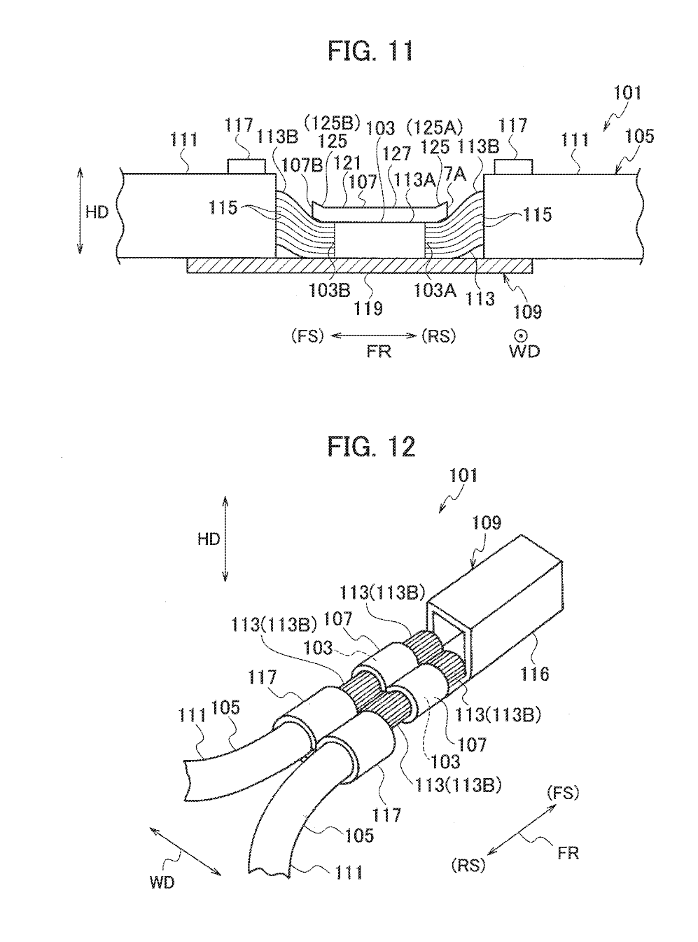

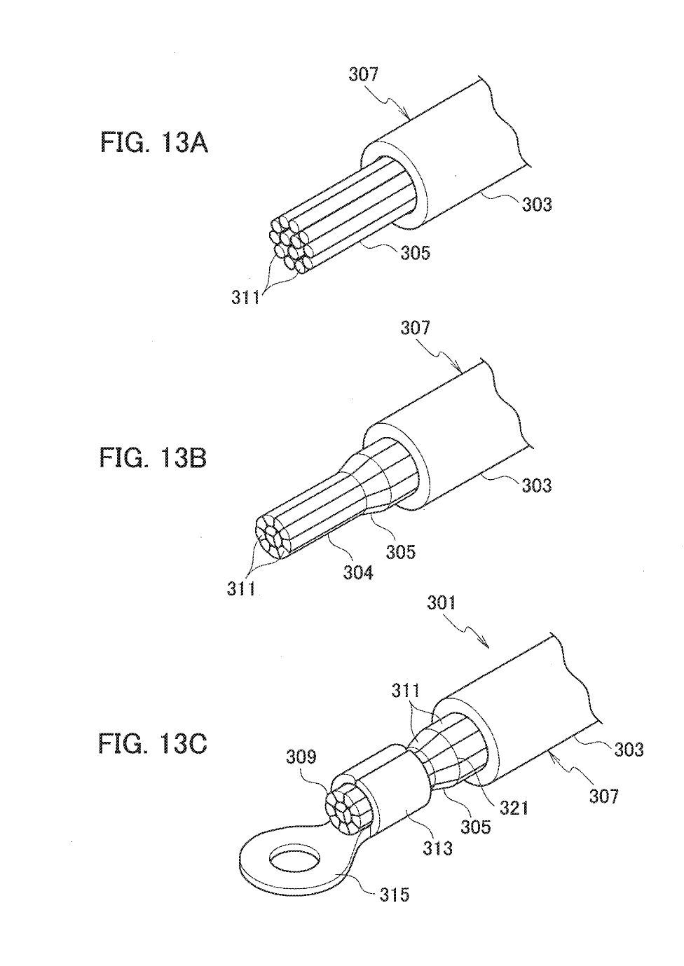

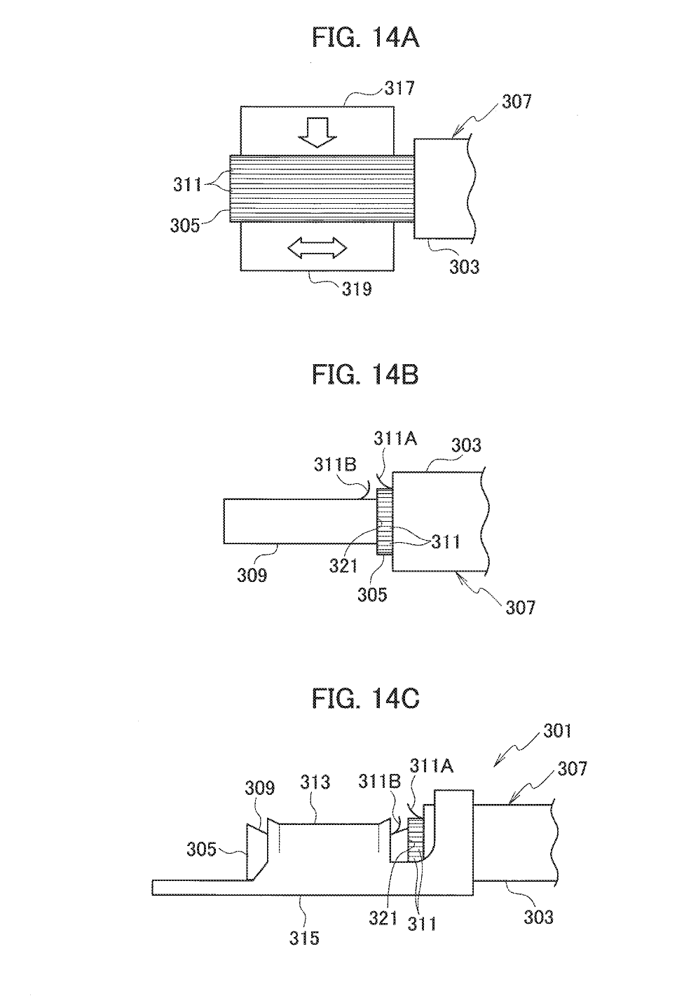

Although the bonded portion 3 is formed at one end portion of the electric wire 9 in the longitudinal direction and the terminal 15 is fixed to the bonded portion 3 in the above description, the bonded portion 3 may be formed at an intermediate portion of the electric wire 9 in the longitudinal direction, and the terminal 15 may be fixed to the bonded portion 3 as illustrated in FIG. 11.

More specifically, the terminal 15 may be fixed to the bonded portion 3 of the electric wire in which the conductor 7 covered with the sheath 5 (an one-end-side portion of the electric wire where the sheath is present), a conductor in the non-bonded state (a conductor in the non-bonded state at one end side), the bonded portion 3, a conductor in the non-bonded state (a conductor in the non-bonded state at the other end side), and the conductor 7 covered with the sheath 5 (an other-end-side portion of the electric wire where the sheath is present) are arranged in this order from one side to the other side in the longitudinal direction of the electric wire 9.

The load release portion (load release portion at one end side) 17, the body portion 19, and the load release portion (load release portion at the other end side) 17 are arranged in the bonded portion 3 in this order from one side to the other side in the longitudinal direction of the electric wire 9.

Further, the single terminal 15 is fixed to the single electric wire 9 in the above description, but one terminal 15 may be fixed to a plurality of (for example, two) electric wires 9 as illustrated in FIG. 12.

Further, when one terminal 109 is fixed to a plurality of electric wires 105, a bonded portion 103 is formed individually in each of conductors 113 of the electric wires 105 and the one terminal 109 may be fixed to each of the electric wires 105, or alternatively, the conductors 113 of at least two electric wires 105 among the respective electric wires 105 may be collected to form the bonded portion 103 at such a collected portion and the one terminal 109 may be fixed to the respective electric wires 105.

Further, when the one terminal 109 is fixed to the plurality of electric wires 105, at least one electric wire 105 among the respective electric wires 105 may have a form in which the bonded portion 103 is formed at an intermediate portion of the electric wire 105 in the longitudinal direction.

What is claimed is:

1. A terminal-equipped electric wire comprising:
an electric wire including a bonded portion formed at a part of a conductor exposed due to absence of a sheath at a part of the electric wire in a longitudinal direction and in which strands of the conductor are bonded to each other; and
a terminal including a wire barrel portion, the wire barrel portion covering at least a part of the bonded portion,
wherein the bonded portion is provided with a load release portion configured to reduce stress applied to the conductor.

2. The terminal-equipped electric wire according to claim 1, wherein
the load release portion is provided in at least one end portion of the bonded portion in the longitudinal direction, and
a diameter of the bonded portion gradually increases toward an end of the bonded portion in the load release portion.

3. The terminal-equipped electric wire according to claim 1, wherein
one terminal of the terminal is fixed to a plurality of the electric wires.

4. A terminal-equipped electric wire comprising:
an electric wire including a bonded portion formed at a part of a conductor exposed due to absence of a sheath at a part of the electric wire in a longitudinal direction and in which strands of the conductor are bonded to each other; and
a terminal including a wire barrel portion, the wire barrel portion covering at least a part of the bonded portion,
wherein a diameter of the bonded portion gradually increases toward an end of the bonded portion in an end portion of the bonded portion.

5. The terminal-equipped electric wire according to claim 4, wherein
one terminal of the terminal is fixed to a plurality of the electric wires.

6. A method for manufacturing a terminal-equipped electric wire, the method comprising:
forming, in an electric wire, a bonded portion in which strands of a conductor are bonded to each other in at least a part of the conductor in a longitudinal direction exposed due to absence of a sheath at a part of the electric wire in the longitudinal direction; and
fixing a terminal including a wire barrel portion to the electric wire such that the wire barrel portion covers at least a part of the bonded portion,
wherein at least one end portion of the bonded portion in the longitudinal direction is provided with a load release portion configured to reduce stress applied to the conductor.

7. An electric wire comprising
a bonded portion, in which strands of a conductor are bonded to each other, formed at least at a part of the conductor in a longitudinal direction exposed due to absence of a sheath at a part of the electric wire in the longitudinal direction,
wherein a diameter of the bonded portion gradually increases toward an end of the bonded portion in an end portion of the bonded portion.
